(19) United States
(12) Patent Application Publication
(10) Pub. No.: US 2013/0094677 A1
(43) Pub. Date: Apr. 18, 2013

(54) COMPOUND MULTI-SPEAKER WITH MODULAR STRUCTURE

(71) Applicant: Lew Stude, Burbank, CA (US)

(72) Inventor: Lew Stude, Burbank, CA (US)

(21) Appl. No.: 13/272,458

(22) Filed: Oct. 13, 2011

(51) Int. Cl. H04R 1/00; H04R 31/00

(52) U.S. Cl. 381/182; 29/594

(57) ABSTRACT

A method and an article of manufacture are disclosed for creating a speaker with a diaphragm of a desired size and shape by joining the frames and cones of two or more speakers together using a straight or V-shaped bridge between each adjacent pair. The compound multi-speaker makes it possible to achieve the increased diaphragm area needed for large sound systems without increasing the number of diaphragms, thus avoiding phase cancellation problems.

### TECHNICAL FIELD

This application relates generally to speakers. More specifically, this application relates to a method and apparatus for creating a compound integrated speaker from multiple individual speakers.

### BRIEF DESCRIPTION OF THE DRAWINGS

The drawings, when considered in connection with the following description, are presented for the purpose of facilitating an understanding of the subject matter sought to be protected.

FIG. 1A shows an example cut-away perspective view of an internal configuration of a speaker;

FIG. 1B shows an example cut-away side view of the internal configuration of the speaker shown in 1A;

FIGS. 1C and 1D show examples of front and back views, respectively, of the speaker shown in 1A;

FIG. 2A shows an example cut-away side view of two speakers joined by a straight bridge to form a compound multi-speaker;

FIG. 2B shows an example front view of the two speakers joined by a straight bridge to form the compound multi-speaker shown in 2A;

FIG. 2C shows an example front view of six speakers joined by straight bridges to form a compound multi-speaker;

FIG. 3A shows an example cut-away side view of four speakers connected by a V-bridge joining four straight bridges to form a compound multi-speaker (This cut-away is the same for east/west and north/south cross-sections; therefore, only two speakers are visible.);

FIG. 3B shows an example front view of four speakers connected by a V-bridge joining four straight bridges to form the compound multi-speaker shown in 3A;

FIG. 3C shows an example front view of 12 speakers and straight bridges, joined by a V-bridge to form a compound multi-speaker; and

FIG. 3D shows an example front view of twenty-four speakers joined in an expanded double V-bridge configuration forming a 45″×90″ compound multi-speaker.

### DETAILED DESCRIPTION

While the present disclosure is described with reference to several illustrative embodiments described herein, it should be clear that the present disclosure should not be limited to such embodiments. Therefore, the description of the embodiments provided herein is illustrative of the present disclosure and should not limit the scope of the disclosure as claimed. In addition, while the following description references certain internal and external configurations of speakers, such as fixed or natural field magnet cone speakers, it will be appreciated that the disclosure may apply to other speaker technologies, such as electrically induced field magnets, and the like.

Briefly described, a method and an article of manufacture are disclosed for creating a speaker with a diaphragm of a desired size and shape by joining the frames and cones of two or more speakers together using a straight or V-shaped bridge between each adjacent pair. The voice coils can be wired in parallel, series, or series parallel and powered by one or more amplifiers as long as all of the voice coils receive identical input signals to work in synchrony, driving the combined unified diaphragm of the compound multi-speaker as a single speaker. Although the drawings and descriptions demonstrate the principles of the compound multi-speaker with respect to a low frequency speaker, the same method can be used to expand a mid-range or high frequency device. To date, all large sound systems are built by combining many speakers. Precise positioning of the speakers in relationship to each other is crucial to minimize phase cancellation caused by multiple speakers producing the same sound. The compound multi-speaker makes it possible to achieve the increased diaphragm area needed for large sound systems without increasing the number of diaphragms, thus avoiding phase cancellation problems altogether.

A speaker is an electro-acoustic transducer that generates sound in response to an electrical input signal, generally representing a sound in the audible frequency range. The most common type of speaker uses a diaphragm, usually cone-shaped and made of paper, connected at the mouth to a rigid frame via a flexible suspension or compliance. The throat of the diaphragm or cone is attached to the top of a cylindrical tube wound with a coil of fine wire, the voice coil. This tube or former is connected to the lower frame via another flexible suspension or spider. The spider constrains the voice coil to move axially through a cylindrical magnetic gap. When an electrical signal is applied to the voice coil, a magnetic field is created by the electric current in the voice coil, making it a variable electromagnet. The voice coil and the adjacent field magnet interact generating a mechanical force that causes the voice coil (and thus, the attached cone) to move back and forth. The movement of the cone creates a compression wave in the air, thereby producing sound. The arrangement of the voice coil and magnet is sometimes termed a motor.

In the 1980s, Cetec-Gauss produced the first speakers to employ a double-spider voice coil suspension. The Gauss double-spider voice coil assembly includes a voice coil wound on a former, glued to two spiders separated by a ring-shaped spacer. The voice coil assembly bolts to the frame which is bolted to the magnet, forming a working motor before the cone and dome are attached. The added stability created by the second spider makes it easier to assemble a sectional diaphragm between multiple motors and an expanded frame. However, theoretically, any speaker could be used in this process.

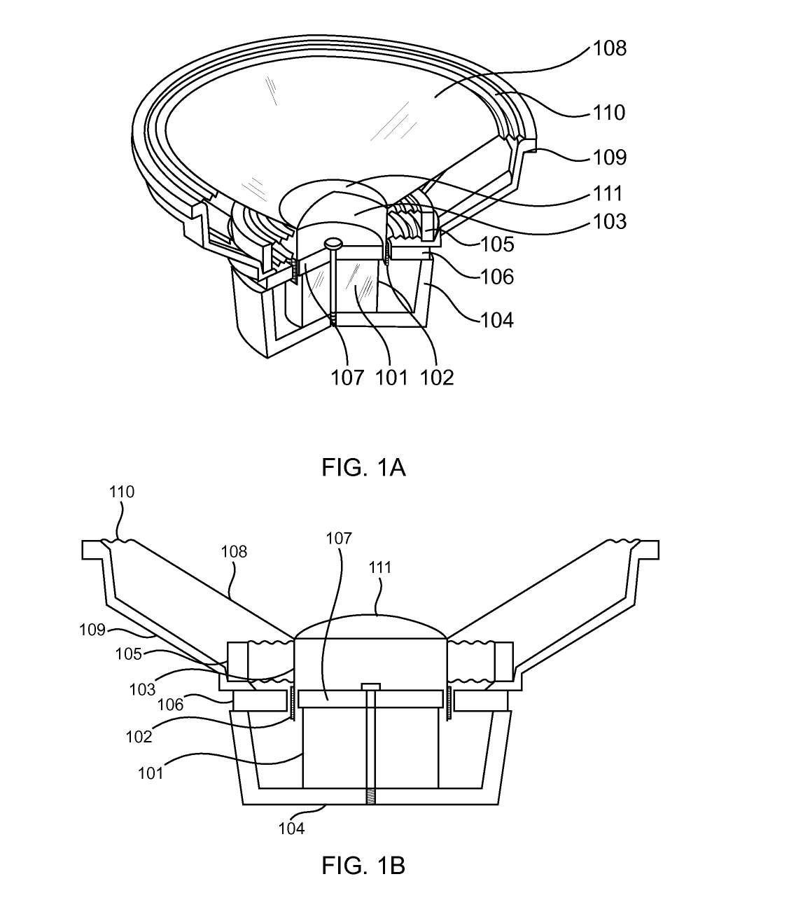

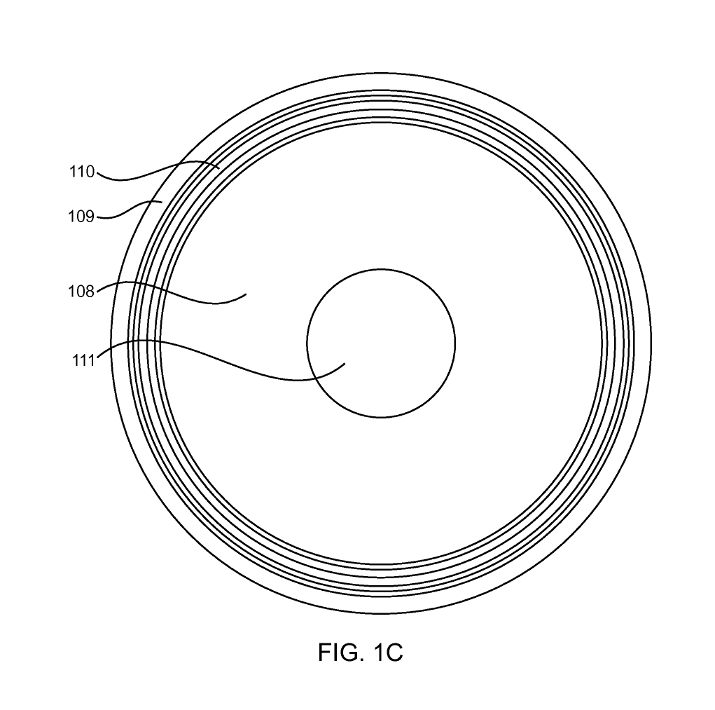

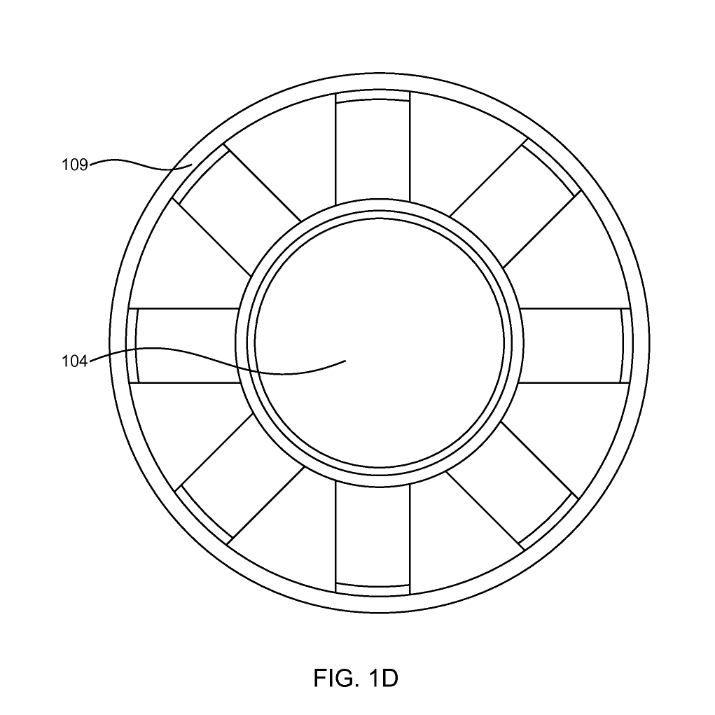

FIG. 1A shows an example cut-away perspective view of the internal configuration of a Gauss 15″ speaker including magnet 101, adjacent to voice coil 102, wound on former 103 and enclosed by back cover 104. The double-spider suspension 105 constrains the motion of the voice coil in the axial direction through the cylindrical physical gap between the top plate 106 and the pole piece 107. The cone 108 is attached to the top of the former, and at the upper edge to the frame 109 with a flexible suspension or compliance 110. The motor is sealed with the dome 111 at the top of the former.

FIG. 1B shows an example cut-away side view of the internal configuration of a Gauss 15″ speaker. This figure shows the same components described above with respect to FIG. 1A, in a side view cross section.

FIGS. 1C and 1D show examples of front and back views, respectively, of a Gauss 15″ speaker. These figures show the external views of the same components described above with respect to FIGS. 1A and 1B, in a front and back view, respectively.

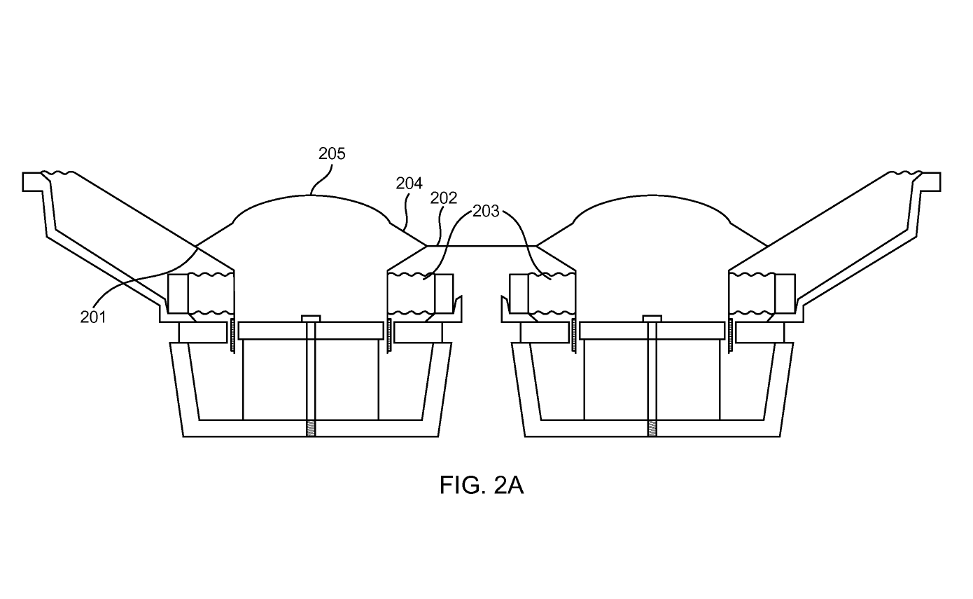

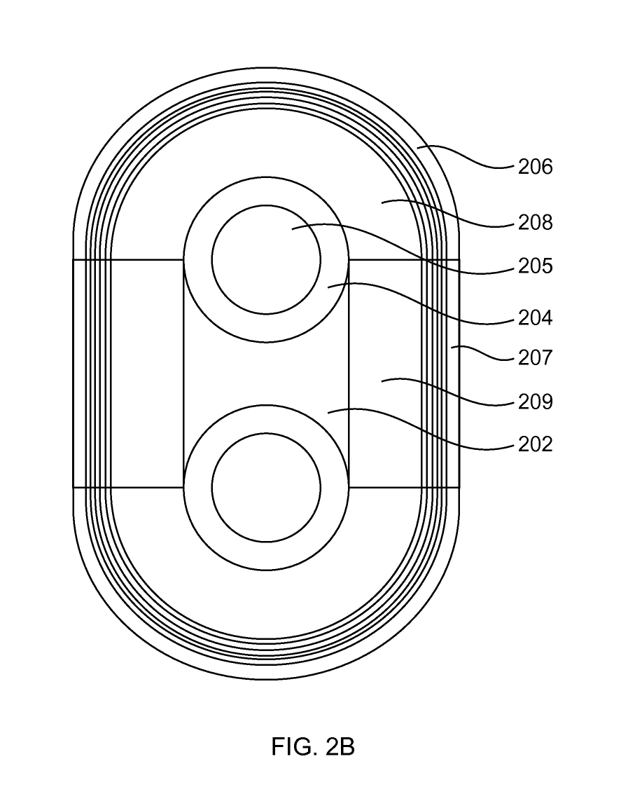

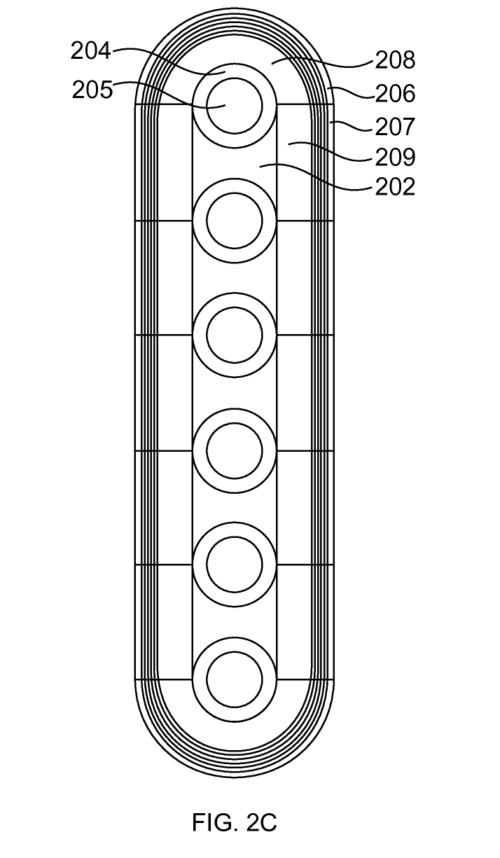

FIG. 2A shows an example cut-away side view of two Gauss speakers joined by a straight bridge to form a 15″×24″ compound multi-speaker. The transmission cones 201 raise the bridge 202 to a level where the motion of the bridge, as part of the diaphragm, is not obstructed by the flexible spider suspension 203 that passes between the two motor assemblies. The dome elevators 204 (inverted transmission cones) make it possible to use standard 4″ domes 205 to seal the motors in the absence of 6″ domes.

FIG. 2B shows an example of a front view of the compound multi-speaker described in FIG. 2A. The frame 206 is built from two Gauss 15″ speaker frames cut in half at the upper rims. The two semi-circular frames are connected with two frame extenders 207 made from ½″ aluminum stock. The lower rims remain intact and bolt to the magnet assemblies. The two cones are cut in half leaving a ring at the base of each for the transmission cones. After the double-spider voice coil assemblies are installed, the partial cones 208, bridge 202 and cone extenders 209 are glued into place. An inverted transmission cone, or dome elevator 204, and a standard 4″ dome 205 seal each motor.

FIG. 2C shows an example front view of six Gauss 15″ speakers joined by five straight bridges to form a 15″×60″ compound multi-speaker. A 9″ cone extension produces a diaphragm double the weight of a single 15″ cone. This means the motors do the same work driving the extended diaphragm as they did driving 15″ cones, and a compound multi-speaker of any size, using a straight bridge expansion constructed of 9″ extensions, will have the same response characteristics as a Gauss 15″ speaker.

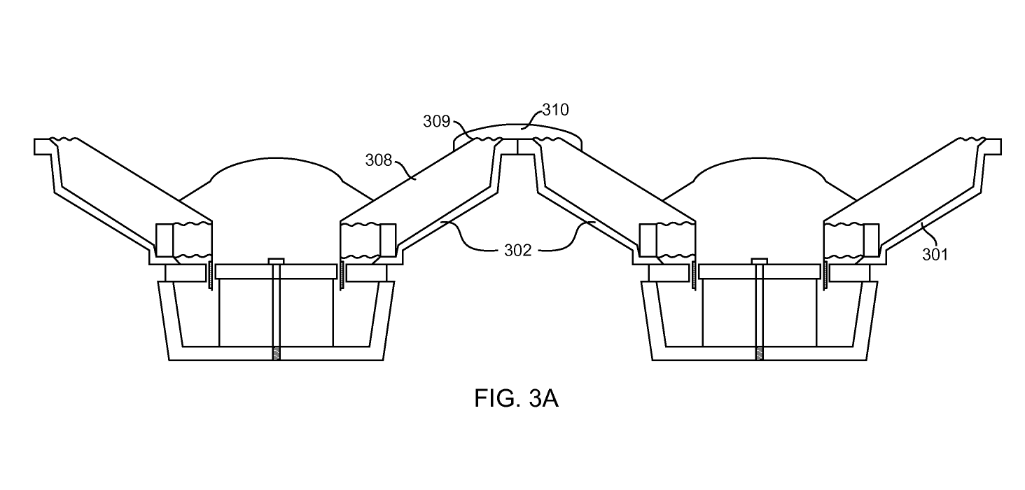

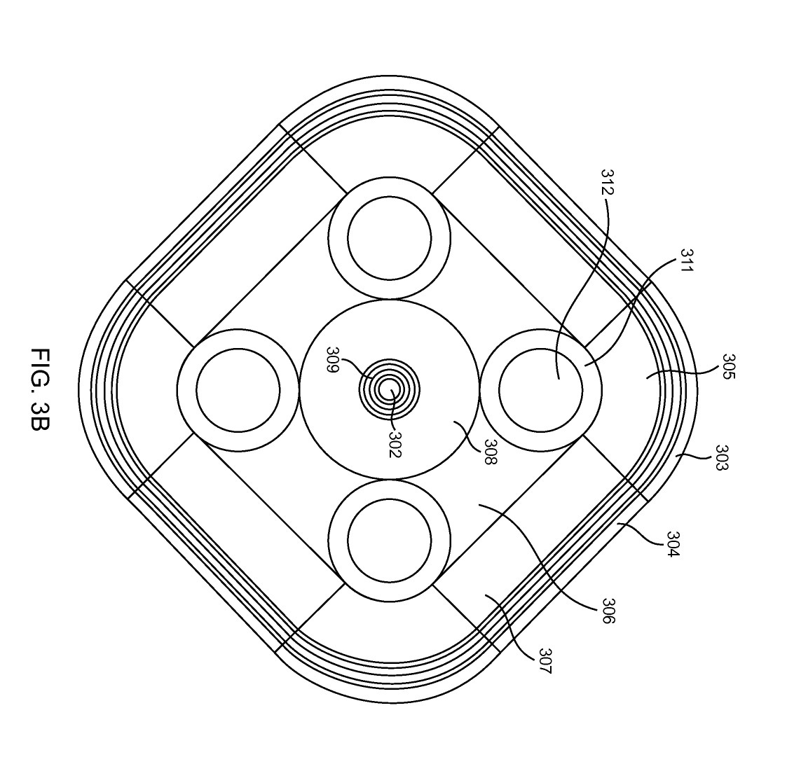

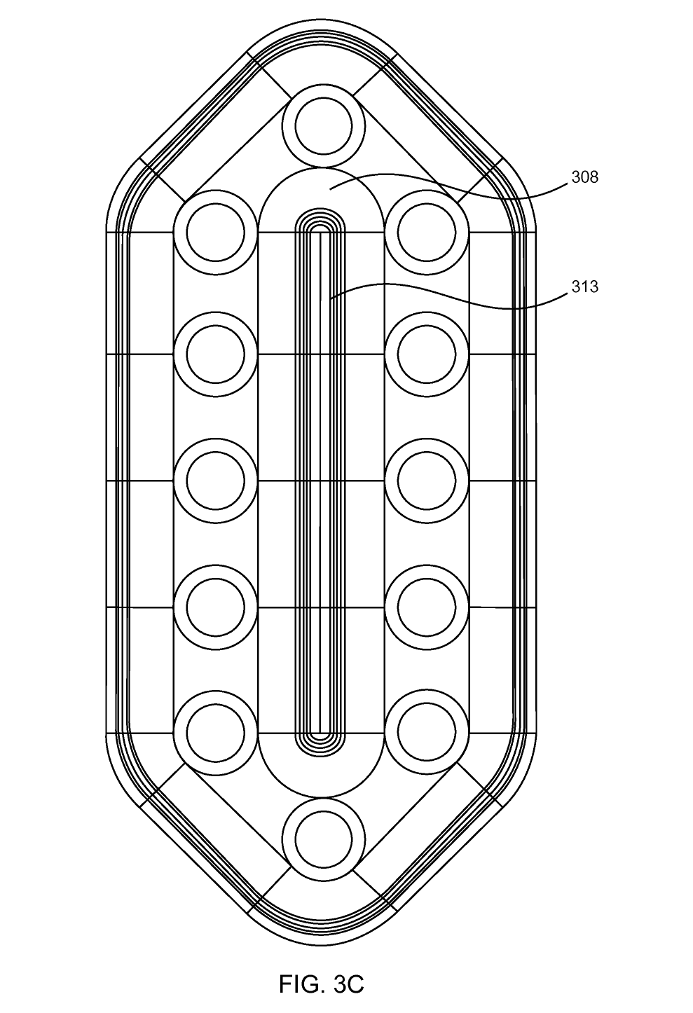

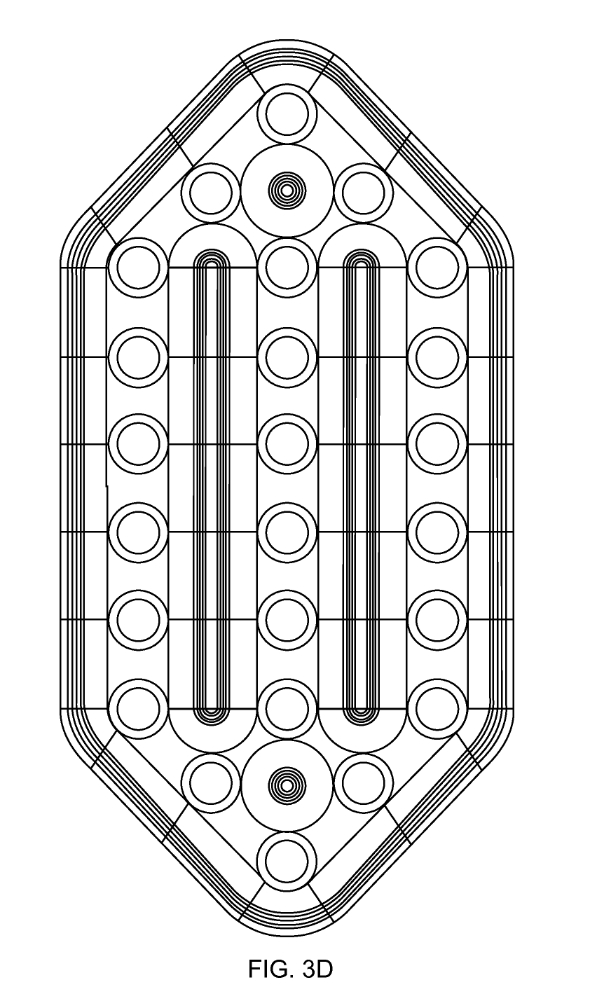

FIG. 3A shows an example cut-away side view of four Gauss speakers joined by a V-bridge connecting four straight bridges to form a 30″×30″ (25″×25″ diagonal) compound multi-speaker. (North/south and east/west cross sections are identical. FIG. 3A represents both, and, therefore, only shows two of the four speakers. To build the frame 301, three quarters of each upper rim of four frames are removed. The rim support spoke directly opposite the remaining quarter circle rim of each frame is left intact. These four spokes are joined in the center of the multi-speaker to form the interior compliance support 302.

FIG. 3B shows an example of a front view of the compound multi-speaker described in FIG. 3A. The four frames 303 are connected at the upper rim with four frame extenders 304 made of ½″ aluminum stock. The intact lower rims are bolted to the four magnet assemblies. Three quarters of each 15″ cone is removed leaving the transmission cone area intact. Following the installation of the four double-spider voice coil assemblies, the four partial cones 305 and four straight bridges 306 are glued into place. Four cone extenders 307 complete the perimeter of the diaphragm while a cut-down inverted 15″ cone forms an interior cone or V-bridge 308. The V-bridge bridges the four straight bridges to the interior compliance 309 which is attached to the interior compliance support 302. A standard 4″ dome is used as a compliance cap 310 (FIG. 3A) and each motor is sealed with a dome elevator 311 and dome 312. The weight of the diaphragm of the V-bridge compound multi-speaker is four times the weight of a single 15″ cone, and, therefore, produces the same response characteristics as a Gauss 15″ speaker.

FIG. 3C shows an example of a front view of twelve Gauss 15″ speakers in a V-bridge configuration, extended by straight bridges to form a 30″×66″ compound multi-speaker. The interior compliance supports are connected with ½″×1″ aluminum stock 313, and the V-bridge cone 308, when cut in half and extended, becomes wedge shaped. The expanded V-bridge compound multi-speaker using 9″ extensions has a diaphragm twelve times the weight of a single 15″ cone, and response characteristics identical to a Gauss 15″ speaker.

FIG. 3D shows an example of a front view of twenty-four Gauss 15″ speakers in an expanded double V-bridge configuration. The four motors on each end are joined by a standard V-bridge to couple the two extended V-bridge wedges. The expanded double V-bridge compound multi-speaker has a 45″×90″ diaphragm and response characteristics identical to a Gauss 15″ speaker.

Changes can be made to the claimed invention in light of the above Detailed Description. While the above description details certain embodiments of the invention and describes the best mode contemplated, no matter how detailed the above appears in text, the claimed invention can be practiced in many ways. Details of the system may vary considerably in its implementation details, while still being encompassed by the claimed invention disclosed herein.

Particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the claimed invention to the specific embodiments disclosed in the specification, unless the above Detailed Description section explicitly defines such terms. Accordingly, the actual scope of the claimed invention encompasses not only the disclosed embodiments, but also all equivalent ways of practicing or implementing the claimed invention.

The above specification, examples, and data provide a complete description of the manufacture and use of the composition of the invention. Since many embodiments of the invention can be made without departing from the spirit and scope of the invention, the invention resides in the claims hereinafter appended. It is further understood that this disclosure is not limited to the disclosed embodiments, but is intended to cover various arrangements included within the spirit and scope of the broadest interpretation so as to encompass all such modifications and equivalent arrangements.

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements.

What is claimed is:

1. A speaker comprising:
at least two individual speakers physically coupled together via a bridge to form a single diaphragm; and
a signal input, configured to receive an electrical input signal, coupled to at least two voice coil motors corresponding to the at least two individual speakers.

2. The speaker of claim 1, further comprising transmission cones configured to raise a bridge away from the at least two voice coil motors.

3. The speaker of claim 1, wherein the bridge is a straight bridge.

4. The speaker of claim 5, further comprising an inverted cone with an interior compliance to bridge said at least to pairs of voice coil motors joined by said straight bridge.

5. The speaker of claim 1, wherein said bridge is a V-bridge.

6. The speaker of claim 1, wherein said bridge is a at least two sets of straight bridges and a V-bridge and wherein said V-bridge is expanded to form a wedge to bridge said at least two sets of straight bridges.

7. The speaker of claim 1, wherein individual speakers are used as building blocks to construct the unified diaphragm to have any geometric shape or size.

8. The speaker of claim 1, wherein individual speakers are used as building blocks to construct the unified diaphragm to have a three-dimensional shape.

9. The speaker of claim 1, wherein the at least two voice coil motors are configured to drive the unified diaphragm under control of the electrical input signal.

10. A method of generating sound, the method comprising:
inputting an electrical signal representing a sound into a signal input of a multi-speaker, wherein the multi-speaker includes at least two individual speakers physically coupled together via a bridge to form a single diaphragm, and the signal input is configured to receive and deliver the electrical input signal to at least two voice coil motors corresponding to the at least two individual speakers.

11. The method of claim 10, wherein the bridge is a straight bridge.

12. The method of claim 10, wherein the bridge is a V-bridge.

13. The method of claim 10, wherein individual speakers are used as building blocks to construct the unified diaphragm to have any geometric shape.

14. The method of claim 10, wherein the at least two voice coil motors are configured to drive the unified diaphragm under control of the electrical input signal.

15. A method of manufacturing a multi-speaker, the method comprising:
physically coupling together at least two individual speakers via a bridge to form a single diaphragm driven by at least two voice coil motors.

16. The method of claim 15, further comprising coupling transmission cones to the unified diaphragm.
